(19) United States
(12) Patent Application Publication
(10) Pub. No.: US 2011/0307290 A1
(43) Pub. Date: Dec. 15, 2011

(54) PERSONALIZED CAPACITY PLANNING SCENARIOS USING REUSABLE CAPACITY PLANNING SCENARIO TEMPLATES

(76) Inventors: Jerome Rolia, Kanata (CA); Mustazirul Islam, Rocklin, CA (US); Shiva Prakash Sm, Bangalore (IN)

(21) Appl. No.: 12/815,194

(22) Filed: Jun. 14, 2010

(51) Int. Cl. G06Q 10/00

(52) U.S. Cl. 705/7.25; 705/7.12

(57) ABSTRACT

Systems and methods are described for creating a personalized capacity planning scenario using a reusable capacity planning scenario template. In accordance with one method, a system topology model can be maintained. The system topology model includes tags describing components and constraints on components within the system topology. The tags can be compared with a plurality of reusable capacity planning scenario templates. The capacities of the components can be identified based on at least one of topology and services executing on the components. At least a portion of the system topology model can be replaced with a reusable capacity planning scenario template based on the identified capacities. An impact of the replacement of the at least a portion of the system topology model can be evaluated. A scenario recommendation can be made to an administrator based on the impact.

### BACKGROUND

Business services can involve large applications, such as customer relationship management or electronic commerce applications, which can be used by enterprises. Such services can be related to the operation and success of the enterprises. Business services can also be complex and have many application components, such as enterprise resource planning systems, databases, web application servers, and so forth. Further, business services are often deployed in data center facilities having dedicated physical servers and virtualized shared server pools.

Enterprises sometimes use capacity modeling and planning to ensure appropriate system resources are available to handle workloads of business services, to enable business capabilities, and to provide for target service levels being reached. Often enterprises may consider planning scenarios, such as: consolidating business services to shared resource pools (i.e., private clouds); re-allocating existing resources to better meet operational cost and performance goals; and evaluating the impact of outsourcing aspects of a service (e.g., to rely upon infrastructure-as-a-service or other services entirely).

Capacity planners for computing systems attempt to optimize business services on large and complex systems with a large number of server nodes which are often geographically dispersed. The workloads processed by the business services and the infrastructure in which business services are executed can change over time. Capacity planners also attempt to determine the impact of changes and what solutions to predicted performance issues will be most effective. Capacity planners also often use models based on current system performance to predict how performance will change in response to anticipated or hypothetical changes to the workloads and infrastructure.

It follows that current capacity planning strategies often involve difficult and time-consuming processes. A capacity planner may expend a great deal of time evaluating planning options and alternatives, only to subsequently discard those options or alternatives after discovering little or no advantage is gained by the options or alternatives. Capacity planners are also limited in the number of systems that can be planned for or the complexity of the systems due to the hands-on (e.g., manual) nature of current capacity planning strategies for creating and executing planning scenarios. Manual changes to capacity planning scenarios often also result in errors due to typological or logical mistakes by the capacity planner. In many cases, a capacity planner may not be aware of planning alternatives that can be evaluated.

### BRIEF DESCRIPTION OF THE DRAWINGS

FIG. 1 is a block diagram of a system for reusable capacity planning scenario template creation in accordance with an example of the present disclosure;

FIG. 2 is a block diagram illustrating comparison of tag closures to find a matching reusable capacity planning scenario template in accordance with an example of the present disclosure;

FIG. 3 is a block diagram illustrating binding a template PMDBs with a system PMDB to generate a planning scenario in accordance with an example of the present disclosure;

FIGS. 4a-4b are flow diagrams illustrating optimization and reporting of planning scenarios in accordance with examples of the present disclosure; and

FIG. 5 is a block diagram of a system for creating a personalized capacity planning scenario using a reusable capacity planning scenario template in accordance with an example of the present disclosure.

### DETAILED DESCRIPTION

Reference will now be made to the exemplary examples illustrated, and specific language will be used herein to describe the same. It will nevertheless be understood that no limitation of scope is thereby intended. Additional features and advantages will be apparent from the detailed description which follows, taken in conjunction with the accompanying drawings, which together illustrate, by way of example, features of the reusable capacity planning scenario templates described herein.

Systems and methods are described for creating personalized capacity planning scenarios using reusable capacity planning scenario templates. In accordance with one method, a system topology model can be maintained. The system topology model includes tags describing components and constraints on components or resources within the system topology. Without loss of generality, henceforth the term resources includes business service components, or Information Technology (IT) components and computing resources. The tags can be compared with a plurality of reusable capacity planning scenario templates. The capacities of the components can be identified based on at least one of topology and services executing on the components. At least a portion of the system topology model can be replaced with a reusable capacity planning scenario template based on the identified capacities. An impact of the replacement of the at least a portion of the system topology model can be evaluated. A scenario recommendation can be made to an administrator based on the impact.

Planning scenarios and templates as described herein can account for: a topology of business service application components and hardware infrastructure; constraints upon the services that may affect performance, reliability, and availability; service level requirements; constraints upon facilities such as power usage and space; software licensing; cost; and operational measures, such as resource usage and service levels. Topology and constraint information can be captured in a Configuration Management Database (CMDB), while usage information can be captured in monitoring repositories. Manually collecting usage information, combining the usage information with topology and constraint information, and reflect the usage information and/or the combination of usage information with the topology and constraint information in a planning scenario can be time consuming and error prone according to prior systems and methods. Furthermore, information can change, increasing the difficulty in keeping planning models up-to-date in prior systems and methods. The creation of a reusable planning scenario as described herein can involve automation of the creation, as wells as evaluation and execution of planning scenario templates. Reusable planning scenario template creation, as described herein, can minimize effort expended for optimizing business services while also maximizing business goals (user experience, SLAs). The reusable planning scenario template creation can minimize operational costs (power, space, etc.) while also addressing constraints. Support for creating and evaluating planning scenario templates can help enterprises better manage information technology (IT) environments.

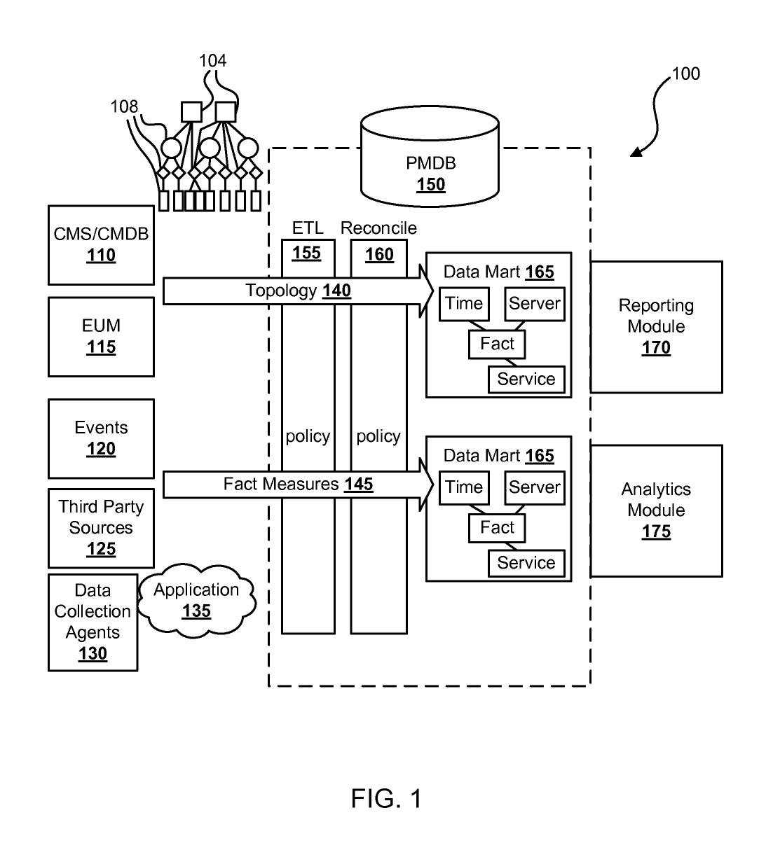

Referring to FIG. 1, a system 100 is shown for the creation of a capacity planning scenario template. The capacity planning scenario template can be created using a computing system and can be created for a computing system. A business service 104 can have various sources of information that describe the configuration, behavior, and resource usage of the service. As shown in FIG. 1, some of these sources of information can include: a configuration management system (CMS) 110, a universal configuration management database (uCMDB) or CMDB 110 (CMS and CMDB are depicted together at reference numeral 110), an end-user manager reporting system for user level metrics (EUM) 115, an events log 120, and third-party sources 125. The CMS and uCMDB can provide topology 140 and service level information. In one aspect, the CMDB can maintain a topology model of available computing resources. The topology model can include computing devices 108 within the system topology. In one aspect, the topology model can also include facilities in which the computing devices are used. The facilities information may comprise a facilities model within the topology model. The inclusion of facilities information with computing device topology information can allow for a capacity planner to not only plan according to projected system resource usage, or a projected number of users, but also according to how much space, power, etc. is available in a particular facility for upgrading to accommodate the projected system resource usage or projected number of users, for example.

As used herein, “uCMDB” or “CMDB” are terms related to a repository that contains management information about business services. The information can be organized according to Business Service Models with elements named Configuration Items (CI). The CIs describe managed objects and their relationships. A Topology Query Language (TQL) can provide an SQL-like language to interface with CMDB systems. CMDBs not only act as repositories for the most recent information about business service topologies but also provide support for change management, asset management, and version control as information evolves. A “CMS” relates to a layer that federates and provides a single interface to multiple proprietary and heterogeneous 3rd party CMDBs. The terms “uCMDB” or “CMDB” are used herein to refer to what may be a federation of CMDBs accessed via the CMS.

The uCMDB 110 can include a dynamic discovery module (DDM). The DDM interacts with a variety of data collection agents 130 to continuously discover information about managed objects and their relationships and to reflect the information in CMDB. Automated discovery is useful in maintaining accurate and up-to-date information. Large systems can have millions of CI and updates to hundreds or more of CI per day. Additionally, IT services may update the CMDB when they make changes to the environment, and automated discovery can complement the tracking of such changes.

Other data sources can provide measurements about the business service(s). The EUM 115, Events 120, and Third-Party Sources 125 shown in FIG. 1 are examples of these other data sources. Data sources can provide information such as workload information. The workload information can include data such as, demand traces for a service on computing components or devices within the system. As a workload consumes computing resources, monitoring systems periodically measure resource demands, including but not limited to CPU and memory usage, and store the measured demand values in a demand trace. In one aspect, the measurements or fact measures 145 about a business service may comprise a service model, and the measurements may comprise information or relationships about or between workloads and demand traces. The service model can also include other information relevant to licensing or service level agreements. As shown in FIG. 1, the third-party sources may comprise an application 135 and/or data collection agents 130 which operate to collect measurements about the business service(s) or measurements relevant to the business service(s).

The topology 140, service level information, and business service measurements 145 can be stored in a performance management warehouse 150, or performance management database (PMDB), within the context a business service's specific hierarchy. This enables the creation of business service optimization scenarios and reports on the results of analysis and/or on measurement data. The business service, or a business service model, may refer to system components such as hosts, virtual machines and so forth. The hosts and virtual machines can have unique identifiers. Monitoring systems produce demand traces for which can have the same unique identifiers as the hosts and virtual machines. When data is loaded into the PMDB via the ETL process a matching process can be performed to correlate the monitoring data from the monitoring system with particular hosts and/or virtual machines in the business service topology.

The PMDB 150 can automatically annotate each item of measurement data, or monitored data, with context information that is defined by each business service's own specific and possibly unique configuration items. For example, within the PMDB, a central processing unit (CPU) measurement can be associated with multiple tags that reflect a position of an application server associated with the CPU within the business service's topology. In prior solutions, a CPU measurement may have only associated a virtual machine (that contains an application server) with a particular physical server. Categorizing data with multiple business service specific tags can provide a number of benefits. For example, all application components that are part of a business service can be selected for study in a planning scenario. Metrics such as CPU usage or power usage at several levels of abstraction (e.g., for a particular application server or for a business service as a whole) can be quickly summarized. Other information such as service level constraints on clusters of application servers can also be available for use in the planning scenario templates. Constraint information can specify a limit for resource utilization levels of each application server or provide that each application server reside on a separate physical server, for example. Other constraint examples include limits on at least one of how, when, and where a workload may be used with regards to available computing resources. Constraints can also include minimal or maximal limits on how, when, or where a workload or resource is used. Constraints can be automatically found when creating planning scenario templates from the PMDB and need not be discovered or added manually by a capacity planner. If a business service changes, a corresponding planning model or template can be updated automatically using the tag-based approach. In one aspect constraints for workloads can be part of a workload model in the PMDB for managing and planning for the workloads in view of the constraints on workloads and/or computing devices.

In one example, some or all of the information for capacity planning templates is stored in the PMDB 150 and can be associated with tags or have tags assigned thereto. For example, tags can be assigned to computing resources within the topology model, to the workload model, to the facilities model, and to the service model. The tags can provide useful information, such as information about topology relationships, workload constraints, and service model services. The tags can provide specific information about particular system devices, such as a type of device, capabilities of the device, power consumption, compatibility, etc. The tags can also enable the system to easily account for constraints such as licensing or service level agreements. For example, a piece of software used in maintaining a business service may only be licensed for use on one or more specific machines. When creating a planning scenario template, a machine(s) limitation for usage of that software can easily be identified and planned for by identifying a tag associated with the software and/or machine(s).

Topology 140, measurement data or fact measures 145, etc., can go through Extract Transform Load (ETL) 155 and reconciliation 160 processes to conform to the information in the PMDB 150. In other words, data can be extracted from outside sources, transformed to fit operational standards in the PMDB, and loaded into the PMDB. The information loaded into the PMDB can be reconciled with information already in the PMDB. The PMDB can include user-configurable ETL and reconciliation policies for handling of topology, measurement data, etc. In one aspect, the policies for handling of topology information can vary from policies used in handling measurement information. After ETL and reconciliation, the data can be stored in a data mart 165 within the PMDB. The PMDB can include a single data mart for storing all of the capacity planning data or multiple data marts, such as a data mart for topology information, a data mart for measurement data, etc. The data mart can record information about data stored in the data mart. For example, the data mart may store information such as the time the data was received, the server from which the data was received, a fact (such as topology or measurement data), a service associated with the fact, etc. This information can be associated with the data in the form of tags, as described above. Because these tags can provide information on constraints, as well as topology relationships and so forth, the tags may also be generally referred to as “constraint tags” herein.

The PMDB 150 can be used to generate a capacity planning scenario template for available computing resources based on the assigned constraint tags. For example, the topology model, the workload model, and the service model may be combined in the PMDB, and a capacity planning scenario template can be generated based on the combined models in the PMDB. A system administrator may be apprised of the capacity planning scenario via generation of a report, using a reporting module 170. An analytics module 175 can also provide an analysis of system performance of the generated capacity planning scenario template and may further provide a comparison with performance of the current system configuration or the configuration of another planning scenario template.

A business service may have many component workloads. Each workload may have certain objectives (e.g., maintain utilization of allocation remain below a threshold). The business service may have additional objectives (e.g., total power usage must be less than some objective). Workloads can have joint constraints (e.g., certain workloads must or must not be on the same physical server, limit on min/max number of replicates of an application component, component must reside on a host with a particular license, etc.). Facilities, e.g., rooms and buildings, may have constraints on peak power, time of day power, limits on space, etc. The uCMDB and/or the PMDB can capture constraint information in the context of business services and facilities. Some of the information in the PMDB may comprise information about mechanisms to get resource demand traces for constituent workloads, relationships between workloads, resource allocation policies for workloads, licensing constraints, business service objectives, etc. The facilities model can capture constraints on power, space, and other aspects of infrastructure to be reflected in a reusable capacity planning scenario template.

The capacity planning scenario template generated from the PMDB may comprise the view of the system or a proposed system in the PMDB. For example, the template may comprise a topology, fact measurements, constraints, etc. The template may be based on actual or hypothetical topologies, measurements, etc. The template may comprise a planning scenario which can be evaluated by a user in comparison with other templates. A template may be created, for example, when a user creates a planning scenario. The template need not be implemented at the time the planning scenario is created. The template can be stored in the PMDB for later use. Templates can range from a very narrow to a very broad scope. For example, a template may describe a single hardware device, or only a portion of a device. A template may describe a single business service or a portion of a business service. Alternately, a template may describe a very large number of devices or business services. Configuration items within the template, such as server or network element, can be ready to be bound to other aspects of performance scenarios. Thus, a template may comprise a portion of a scenario to be bound with another scenario or template. An overall planning scenario can be created using one or more templates from the PMDB.

Scenario planning using reusable templates can enable faster and more efficient scenario planning. For example, a template may describe a new server. A customer may wish to analyze how the addition of the new server may impact the customer's business service. If a template describing the features of the new server is readily available, the customer can quickly and easily replace an existing server with the new server in the capacity planning system to run reports and analyze performance without having to learn all of the specific information about the new server or without having to re-describe an entire system. In another example, a user may already have a system using a pool of new servers. The user may wish analyze business service performance with an additional new server pool in the system. Because the system can be described using templates, a template for the new server pool may easily be identified, duplicated, and appended to the system configuration in a planning scenario to determine the effect of the additional new server on business service performance.

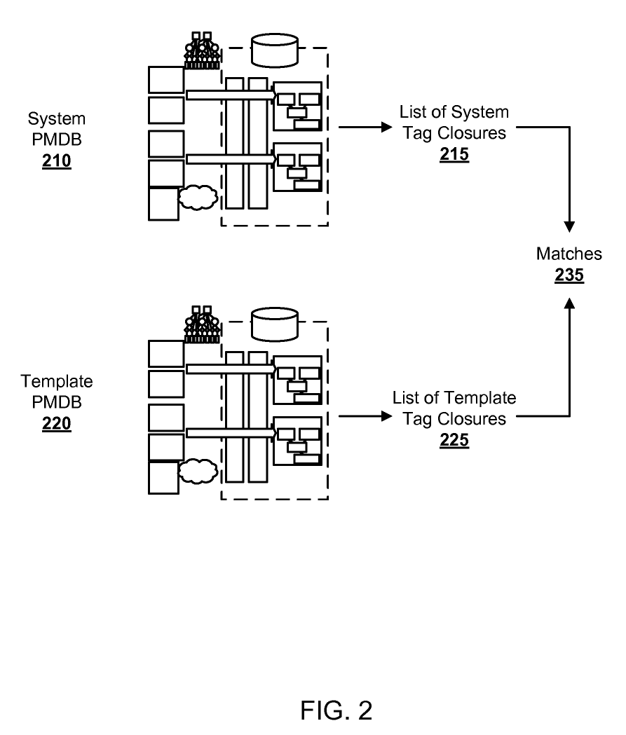

FIG. 2 is a block diagram illustrating comparison of tag closures to find a matching reusable capacity planning scenario template in accordance with an example of the present disclosure. System PMDB 210 and template PMDB 220 can be derived from configuration items in a service model. The configuration items can have different types. Some example configuration item types include server resource pools, servers, networking elements, web service interfaces for specific functions, etc. A system PMDB can have a closure of configuration items, or in other words, a closure of tags or constraint tags, for each branch of the business service topology. A closure can refer to a complete set of tags or configuration items. For example, a closure may include a set of servers used or a resource pool of servers used. The system PMDB can also include a closure of configuration items or constraint tags for each branch of infrastructure topology of the system. For example, an infrastructure closure may include a set of servers offered, a resource pool of servers offered, and so forth. The reusable capacity planning scenario template can have closures similar to the closures of the system PMDB. A tag comparison module can be used to compare a list of system tag closures 215 for various parts of the service model topology found in the system PMDB with the list of template tag closures 225 in a template PMDB. The tag comparison module can determine whether there is a template with one or more closures that “match” 235 one or more closures of the system PMDB. A “match,” as used herein, refers to a closure of tags from a branch of a topology in the system PMDB that correspond semantically with the closure of tags from a template PMDB. The tag comparison module can use a brute force method to enumerate closures from the system PMDB and various templates to find templates with the same types of tags and/or closures of tags. Additionally, the tag comparison module could be assisted by inputs from a capacity planner. For example, the tag comparison module can be configured to perform a brute force matching operation, or enumeration of tags, which can be at least partially guided by the capacity planner. For example, the capacity planner can provide input on specific templates which are likely to have a greater positive impact than others. Also, templates can be arranged or ordered according to which templates are likely to have a greatest impact such that earlier found matching templates are likely to have a greater impact than later found templates and can be evaluated sooner rather than later.

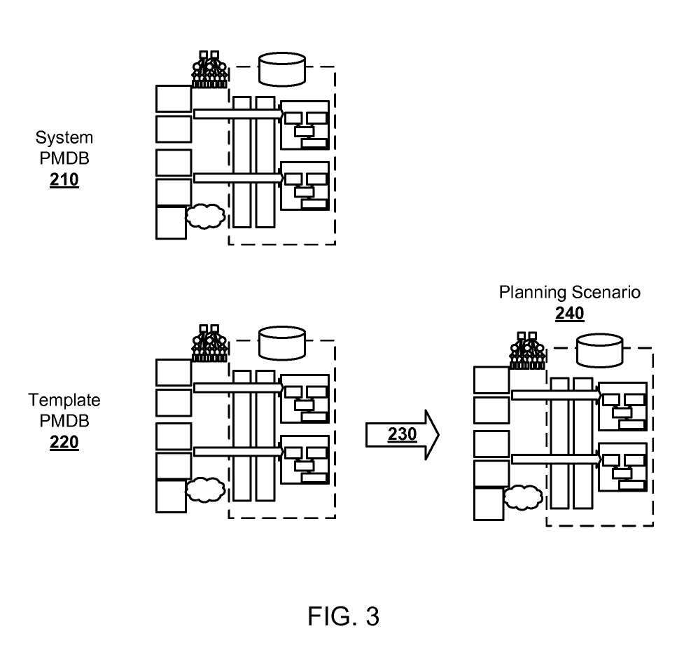

Referring now to FIG. 3, use of the reusable capacity planning scenario templates in a planning scenario will be described. A system resource template or system PMDB 210 can be maintained. The system resource template may comprise the current system configuration. The system resource template can also include constraint tags for system hardware and services in the current system configuration. The system resource template can also include information about data usage, numbers of customers, and other such information which may be founding a planning scenario as created using the planning scenario system. In short, the system resource template can be a currently invoked planning scenario. For this reason the system resource template shown in FIG. 2 or FIG. 3, as well as other alternative or reusable templates not shown, are each depicted substantially similar in appearance to the system of FIG. 1. In one aspect, the system resource template may comprise a PMDB. As shown in FIG. 2, the system resource template comprises a system PMDB. The system PMDB may be comprise one template among many stored in a master PMDB configured for managing and creating PMDB templates.

The master PMDB may comprise any number of reusable capacity planning scenario templates or template PMDB 220. Like the system resource template, these reusable templates can include topology, resource usage information, constraint tags, and so forth. In one aspect, the reusable templates can include constraint tag for at least some of the same system hardware and services that are present in the system resource template.

A planning scenario 240 can be created by re-writing 230 at least one constraint tag in the system resource template 210 to refer to at least one constraint tag in one of the available reusable capacity planning scenario templates or template PMDB 220. Re-writing the constraint tags in this manner can bind the reusable capacity planning scenario template(s) to the system resource template. As described above, a customer system PMDB can have tags for elements such as servers, specific types of services, etc. These tags can define associations between services, devices, and so forth. These associations can be replaced by using tags in a reusable template rather than the original system tags. Because the reusable template PMDB can have similar tags to the system PMDB, template infrastructure and services can easily be replaced in the original system infrastructure and services by rewriting the tags, as described. Re-writing the tags can cause the elements of the reusable template to be used in the system template as part of the hierarchy for facilities, business services, etc. Performance, power, and cost information computed in the planning scenario can also use the information from the templates rather than the original customer system.

An optimization can be used to solve for how best to achieve system goals. For example, a system goal may be best achieved by consolidating services or resources, or by adding additional hardware. The optimization can include, for example, a determination of how many new servers to add to achieve a predetermined performance benchmark. In one aspect, the scenario optimization can be performed using the bound reusable capacity planning scenario template and the system resource template. The optimization can include before and after comparisons made with respect to costs, space, power, or other metrics.

In one example, optimization may occur by altering a services and computing resource relationship. In other words, inclusion of new hardware, change in configuration of hardware or services, or rearrangement of which hardware is used for which service(s) or for a particular aspect of a service, etc., can improve service performance or decrease system resources used for the service. Therefore, the optimization may comprise testing various different configurations, arrangements, potential new hardware, etc. to determine an optimized configuration, or a configuration with a performance increase.

Also, the optimization can include solving “what if” scenarios. Solving a “what if” scenario may comprise solving for potential changes in future usage of the available computing resources. Solving a “what if” scenario may comprise solving for potential changes in number of users of the available computing resources. Further, solving a “what if” scenario may also comprise solving for potential changes in future available computing resources. Other examples of potential what if scenarios and optimizations that may be apparent to one having skill in the art are also contemplated. The PMDB or data mart can be updated with the optimization result. In one aspect, updating the data mart with the optimization or the result may comprise updating the constraint tags in the data mart. The updated data mart can report an optimized planning scenario to an administrator. For example, specific computing resource usage metrics can be reported to the administrator, or user. In one aspect, the reported information can be defined by the user and based on the constraint tags. In another aspect, a planning scenario may be reported to a user only when the performance of the scenario as compared with the current system configuration exceeds a predetermined threshold. For example, the predetermined threshold may be a minimal decrease or increase in system performance.

In one aspect, the updated data mart information can be used to implement the planning scenario. In another aspect, a capacity planning scenario template can be created based on the updated data mart. This capacity planning scenario template can be a further improvement on a previous capacity planning scenario template, or may be a different planning scenario template simply created based off the updated information. Storing solutions to optimizations and what if scenarios can make further reusable planning scenario template creation faster and more efficient by eliminating the need to solve the optimizations or what if scenarios again in the future for similar situations.

By using a PMDB for templates as described herein, branches of a system model can easily be replaced with similar branches defined in a template. A capacity planner need only be aware of what branches should be re-written rather than being aware of how to describe the contents of the template, thus simplifying capacity planning. Also, a capacity planner can try out many new planning scenarios quickly without expending a great deal of time and with a lower skill level than may be possible using previous approaches. Capacity planning is simpler and faster because information can be already captured in a template model and the user need have no a-priori knowledge of all the possibilities that can alternatively be presented via templates as described herein.

Prior capacity planning solutions involved the creation of a model of the system for study. In these prior solutions, a capacity planner fully reflected proposed changes to a system in the model in order to be able to study the impact of the planning solution. This could be time consuming and in some instances a capacity planner may not have the experience or knowledge to adequately describe some of the proposed changes. Prior solutions have also involved fixed levels of abstractions that were considered in models. In contrast, with templates, as with other parts of capacity planning models based on PMDB, the capacity planner can design a capacity planning scenario that focuses on specific portions of the system rather than a fixed abstraction level of a model. Appropriate constraints for the existing system and the templates can be automatically discovered and rendered into the planning scenario.

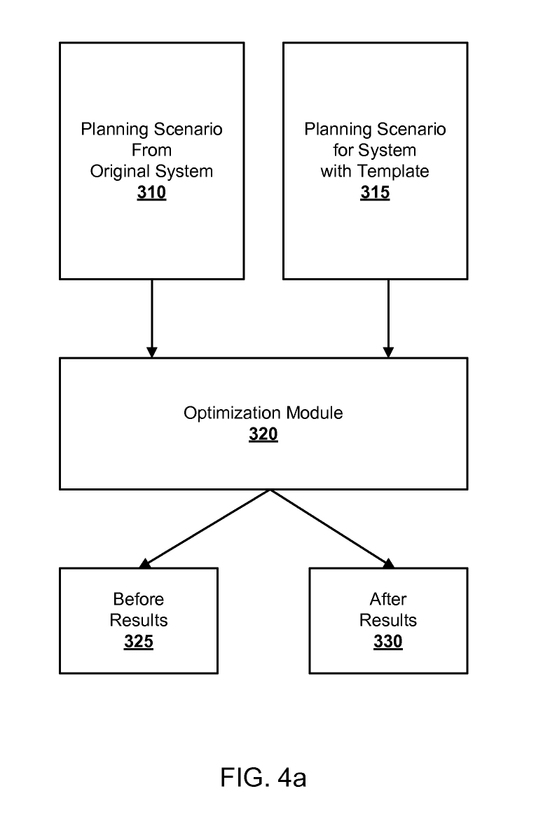

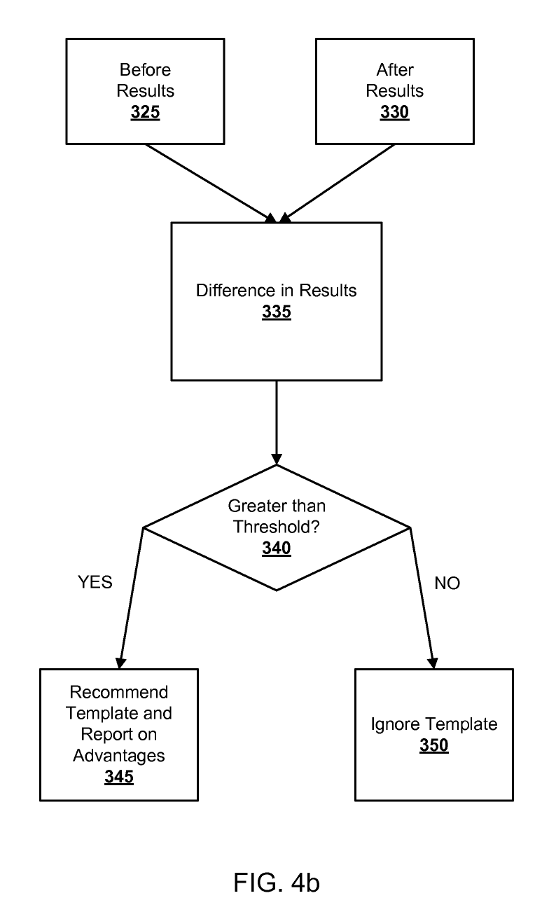

FIGS. 4a-4b set forth flow diagrams illustrating optimization and reporting of planning scenarios in accordance with examples. Optimization or modification of capacity planning scenarios has been described above. As shown in FIG. 4a, planning scenarios can be generated, including constraints. The planning scenarios can include a planning scenario for the original system 310 and for a planning scenario for a system using a reusable capacity planning scenario template 315. Optimization or modification can be performed using an optimization module 320 (or modification module) on the planning scenario for the original system or for the planning scenario for a system using the reusable capacity planning scenario template, as described above in FIGS. 2-3. The optimization can include optimization with respect to the goals of the capacity planner (available via the PMDB) and other goals deemed relevant by the optimization module. Some examples of other goals which may be relevant include power, cost, facility space, etc. The optimization module can output before optimization results 325 and after optimization results 330. The before and after results can include before and after results for both the planning scenario for the original system or for the planning scenario for a system using the reusable capacity planning scenario template.

FIG. 4b continues from FIG. 4a with the before results 325 and after results 330 resulting from the optimization by the optimization module. The before and after results can be compared for metrics of interest to the capacity planner. In one aspect, the metrics of interest can be related to the optimization goals. If the difference in results 335 between the before and/or after results exceeds a predetermined difference value 340 (e.g., is greater than predetermined threshold), or a difference value specified by the capacity planner, then the system can use a reporting module to report 345 that the optimization (either of the original system or of the system with the template) is worth considering by the capacity planner. The reporting module can further report advantages of the optimization to the capacity planner. The reporting module can report on one or multiple planning scenarios in a single report. Likewise, if the difference between the before and/or after results exceeds a predetermined difference value then the system can use the reporting module to report that pre-optimization system with template is worth considering by the capacity planner, along with advantages of the pre-optimization system with template. If the before and after results do not results in a result difference greater than the threshold predetermined value, the system can be configured to ignore 350 the template and/or the optimization. In other words, the system can be configured to not report the template and/or the optimization when the threshold is not exceeded.

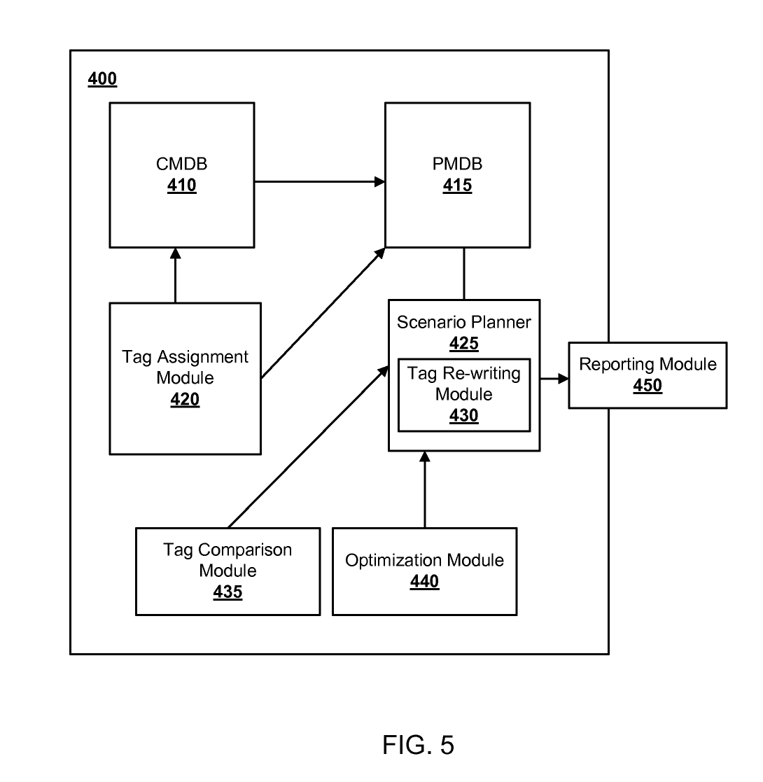

Referring now to FIG. 5, a system 400 is shown for creating a personalized capacity planning scenario using reusable capacity planning scenario templates. The system is similar in many regards to the systems described above. The system can include a CMDB 410 for maintaining a system topology of devices, services, etc. The system can include a PMDB 415 in communication with the CMDB and configured to receive topology information from the CMDB. The topology information, as well as service measurement data or facts can be projected, or uploaded, to the PMDB. A constraint tag assignment module 420 can be used to assign constraint tags to the projected topology model and facts. As described above, the constraint tags may comprise information about topology relationships, computing device capabilities, services operated on the plurality of computing devices, and so forth. The system can include a scenario planner 425 for to creating a reusable capacity planning scenario template with constraints based on the topology model, facts, and constraint tags from the PMDB. The scenario planner can include a tag re-writing module 430. The tag re-writing module can be configured to re-write tags in a system resource template to refer to tags in a reusable scenario template to bind the templates together.

In one aspect, tag re-writing can include selecting a service or hardware from the system resource template and replacing the service or hardware with a replacement service or replacement hardware from a reusable capacity planning scenario template. Also, tag re-writing can include associating a service or hardware from the system resource template with an additional service or additional hardware from the at least one reusable capacity planning scenario template.

The system can include a tag comparison module 435 configured to compare the tags or closures of tags from the system PMDB with one or more template PMDBs to find a match to determine an appropriate template to use with the system PMDB.

The system can include an optimization module 440 configured to provide optimizations of the original system PMDB and/or the system PMDB with a template. The optimization module can compare before and after results of optimizations, and/or results of inclusion of a template with the original system PMDB. The optimization module can be used in communication with a reporting module 450 to report when the results exceed a predetermined threshold.

The system can include an intelligent editing module. The intelligent editing module can be configured to perform intelligent editing of tag rewriting. The intelligent editing module may comprise rules to restrict what replacements or associations of tags or closures are permitted based on the types of selected items. In other words, the rules can be configured to guard against actions such as replacing a physical server with a database application, for example. In one aspect, the rules can be implemented based on the constraint tags associated with the service topology.

The intelligent editing module can enable a user to easily modify a service topology in an intelligent way. For example, the intelligent editing module may prompt a user to replace servers with a pool rather than just other servers, as may be appropriate. The intelligent editing module can base prompts and decision-making on common patterns for changes in templates. In another example, the reusable templates can include a description of how to make changes to the service topology. For instance, the template may include instructions to replace an item with an item of the same type, to accept virtual machines as parents, to accept virtual machines of servers as parents, to accept specified devices as children, etc.

The intelligent editing module can further invoke other existing technologies to determine whether two “application level services” are compatible. For example, the intelligent editing module may comprise an ontology for services. In one aspect, the ontology may be used to compare a Web Service Definition Language (WSDL) of the business service and a template service.

Using the systems and methods herein, a capacity planner can explore upgrades and new approaches to implementing parts of system without having to fully describe all of the changes to the system in a model. The capacity planner need only re-write tags used to bind the existing view of the system with a template which fully describes the remaining system changes. The capacity planner need not be aware of modeling scenarios or how to encode the modeling scenarios into scenario plans in order to receive reports on potential advantages of different possible scenarios. The capacity planner can remain always up-to-date on impacts of newly available planning alternatives. The capacity planner can also plan for a larger number of systems because less effort is used to plan for each system. Using a system which compares tags or closures and then determines the advantages of potential planning alternatives and only reports planning alternatives meeting a certain threshold, the capacity planner need not waste time evaluating many low-return alternatives in finding alternatives which can offer significant benefits.

Some of the functional units described in this specification have been labeled as modules or engines, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Also within the scope of an example of the systems and methods herein is the implementation of a program or code that can be stored in a machine-readable medium to permit a computer to perform any of the methods described above.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

While the forgoing examples are illustrative of the principles of reusable capacity planning scenario template creation in one or more particular applications, it will be apparent to those of ordinary skill in the art that numerous modifications in form, usage and details of implementation can be made without the exercise of inventive faculty, and without departing from the principles and concepts described herein. Accordingly, no limitation is intended, except as by the claims set forth below.

1. A computer-implemented method for creating a personalized capacity planning scenario using a reusable capacity planning scenario template, comprising:
maintaining a system topology model, including tags describing components and constraints on components within the system topology;
comparing the tags with a plurality of reusable capacity planning scenario templates;
identify the capacities of the components based on at least one of topology and services executing on the components;
replacing a portion of the system topology model with a reusable capacity planning scenario template based on the identified capacities;
evaluating an impact of the replacement of the portion of the system topology model; and
making a scenario recommendation based on the impact.

2. A method in accordance with claim 1, further comprising reporting a reusable capacity planning scenario template when the impact is greater than a predetermined threshold, and wherein the reporting of the reusable capacity planning scenario template is included the scenario recommendation.

3. A method in accordance with claim 1, further comprising ignoring a reusable capacity planning scenario template when the impact is less than a predetermined threshold, and wherein the reusable capacity planning scenario template is ignored and not included the scenario recommendation.

4. A method in accordance with claim 1, wherein creating a personalized capacity planning scenario using a reusable capacity planning scenario template further comprises creating a personalized capacity planning scenario using a reusable capacity planning scenario template automatically and independently of input from an administrator.

5. A computer-implemented method for creating a personalized capacity planning scenario using a reusable capacity planning scenario template, comprising:
maintaining a system topology model, including tags describing components and constraints on components within the system topology;
maintaining a set of business goals in a capacity planning module;
determining whether to create a personalized capacity planning scenario based on performance of the system topology model in comparison to the set of business goals;
identifying a reusable capacity planning scenario template from a plurality of reusable capacity planning scenario templates based on the tags;
replacing a portion of the system topology model with the identified reusable capacity planning scenario template;
evaluating an impact of the replacement of the portion of the system topology model; and
making a scenario recommendation based on the evaluated impact.

6. A method in accordance with claim 5, further comprising identifying the capacities of the components based on at least one of topology and services executing on the components.

7. A method in accordance with claim 6, wherein replacing a portion of the system topology model with the identified reusable capacity planning scenario template further comprises replacing a portion of the system topology model with a reusable capacity planning scenario template based on the capacities identified.

8. A method in accordance with claim 6, wherein evaluating the impact comprises evaluating an impact on one of cost, power usage, and performance of the system topology after said replacing.

9. A method in accordance with claim 6, further comprising determining whether the impact of said replacing exceeds a predetermined threshold, and wherein making a scenario recommendation to an administrator further comprises making a scenario recommendation to an administrator depending on whether the evaluated impact exceeds the predetermined threshold.

10. A method in accordance with claim 6, wherein identifying a reusable capacity planning scenario template from a plurality of reusable capacity planning scenario templates based on the tags comprises comparing tag closures in the system topology model with tag closures in the plurality of reusable capacity planning scenario templates and identifying a system topology branch with a closure semantically corresponding to a closure in a template from the plurality of reusable capacity planning scenario templates.

11. A method in accordance with claim 10, further comprising performing a brute force enumeration of closures from the system topology and the plurality of reusable capacity planning scenario templates to identify the corresponding closures, wherein the brute force enumeration is assisted by input from a capacity planner.

12. A method in accordance with claim 10, further comprising merging the reusable capacity planning scenario template from the identifying step with the system topology model by changing references in the system topology model to the closures to references to the identified reusable capacity planning scenario template closures.

13. A method in accordance with claim 6, further comprising optimizing the replacement of the portion of the system topology model based on the business goals and constraints which comprise information about topology relationships, computing device capabilities, and services operated on the computing devices.

14. A method in accordance with claim 13, further comprising optimizing the system topology model as configured prior to the replacement based on the business goals and constraints.

15. A method in accordance with claim 14, further comprising comparing the optimization of the system topology model as configured before and after replacement of the portion of the system topology model and reporting a result to the administrator.

16. A method in accordance with claim 15, further comprising determining whether the before and after comparison results in a difference greater than a predetermined threshold, and wherein reporting the result to the administrator is dependent on the difference exceeding the threshold.

17. A system for creating a personalized capacity planning scenario using a reusable capacity planning scenario template, comprising:
a configuration management database;
a performance management database;
a constraint tag assignment module configured to assign constraint tags to the projected topology model and facts, wherein the constraint tags comprise information about topology relationships, computing device capabilities, and services operated on the plurality of computing devices; and
a scenario planner configured to recommend a capacity planning scenario based comparison of the topology model, facts, and constraint tags with a reusable capacity planning scenario template from the performance management database.

18. A system in accordance with claim 17, further comprising a reporting module configured to compare a system configuration before and after rewriting the constraint tags and report the impact of the configuration change.

19. A system in accordance with claim 17, further comprising a tag comparison module configured to perform the comparison of the topology model, facts, and constraint tags with the reusable capacity planning scenario template.

20. A system in accordance with claim 17, further comprising an optimization module configured to modify the personalized capacity planning scenario based on business goals and the constraint tags.
